(19) United States
(12) Patent Application Publication
(10) Pub. No.: US 2012/0133336 A1
(43) Pub. Date: May 31, 2012

(54) RECHARGEABLE BATTERY CHECKER

(75) Inventors: DONG HAN, Shenzhen City (CN); SHA-SHA HU, Shenzhen City (CN); BO-CHING LIN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/084,541

(22) Filed: Apr. 11, 2011

(30) Foreign Application Priority Data
Nov. 29, 2010 (CN) 201010563917.4

(51) Int. Cl. H02J 7/04

(52) U.S. Cl. 320/145; 320/162

(57) ABSTRACT

A rechargeable battery checker for measuring the voltage of a rechargeable battery includes a PMIC, a charging switch, a voltage measuring switch, and a control circuit. The charging switch is connected to a charging terminal of the PMIC and the rechargeable battery, to control the PMIC to charge or pause charging the rechargeable battery. The voltage measuring switch is connected to a voltage measuring terminal of the PMIC and the rechargeable battery, to control the PMIC to measure or pause measuring the voltage of the rechargeable battery. The control circuit connects to the charging switch and the voltage measuring switch, and to output a modulated signal, and periodically change the signal to switch on/off the charging switch and the voltage measuring switch. The PMIC determines whether the rechargeable battery is fully charged according to the measured voltage of the rechargeable battery.

### BACKGROUND

1. Technical Field

The present disclosure relates to a checker for measuring the voltage of a rechargeable battery.

2. Description of Related Art

During the process of charging, a voltage measuring device is usually used to measure the voltage of a rechargeable battery to determine whether the battery is fully charged. However, because internal resistance of the battery is usually not accounted for, charging will be automatically stopped before the battery is actually fully-charged, which will shorten the time between charge and discharge, and shorten the service life of the rechargeable battery.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a rechargeable battery checker for measuring the voltage of a rechargeable battery, according to an embodiment.

FIG. 2 is an exemplary circuit diagram of the rechargeable battery checker of FIG. 1.

### DETAILED DESCRIPTION

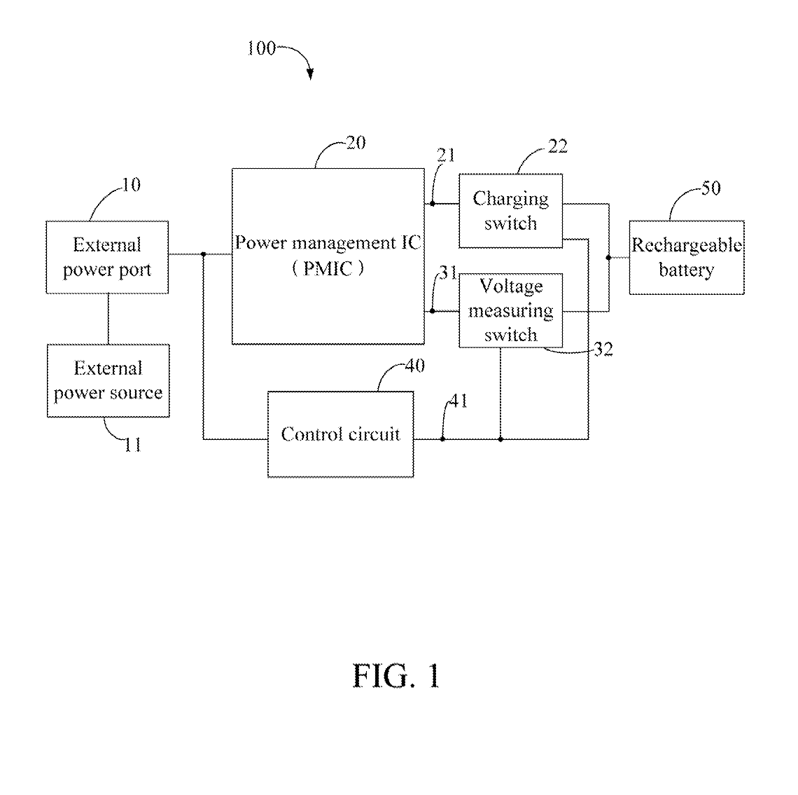

Referring to FIG. 1, a rechargeable battery checker 100 for measuring the voltage of a rechargeable battery 50, according to an embodiment, is illustrated. The rechargeable battery checker 100 includes an external power port 10, a power management IC (PMIC) 20, a charging switch 22, a voltage measuring switch 32, and a control circuit 40.

The external power port 10 is configured to connect to an external power source 11, such as an alternating current power source, to power the PMIC 20 and the control circuit 40. The PMIC 20 includes a charging terminal 21 and a voltage measuring terminal 31. The PMIC 20 charges the rechargeable battery 50 via the charging terminal 21, measures the voltage of the rechargeable battery 50 via the measuring terminal 31, and determines whether the rechargeable battery 50 is fully charged accordingly.

In the embodiment, one terminal of the charging switch 22 is connected to the charging terminal 21, and the other terminal of the charging switch 22 is connected to the rechargeable battery 50, to control the PMIC 20 to charge or pause charging the rechargeable battery 50. One terminal of the voltage measuring switch 32 is connected to the measuring terminal 31, and the other terminal of the voltage measuring switch 32 is connected to the rechargeable battery 50, to control the PMIC 20 to measure or pause measuring the voltage of the rechargeable battery 50.

The control circuit 40 includes a modulated signal output terminal 41, which is connected to the charging switch 22 and the voltage measuring switch 32. The control circuit 40 outputs a modulated signal, and periodically changes the signal via the modulated signal output terminal 41 to switch on/off the charging switch 22 and the voltage measuring switch 32. Such that, the PMIC 20 is enabled to charge the rechargeable battery 50 intermittently, and measure the voltage of the rechargeable battery 50 during a pause of charging.

In the embodiment, the modulated signal output from the modulated signal output terminal 41 includes a first modulated signal and a second modulated signal. During a time period, if the control circuit 40 outputs the first modulated signal to the charging switch 22 and the voltage measuring switch 32, the charging switch 22 is switched on, and the voltage measuring switch 32 is switched off. At the same time, the PMIC 20 charges the rechargeable battery 50 via the charging terminal 21, and pauses measuring the voltage of the rechargeable battery 50. If the control circuit 40 outputs the second modulated signal to the charging switch 22 and the voltage measuring switch 32, the voltage measuring switch 32 is switched on, and the charging switch 22 is switched off. At the same time, the PMIC 20 measures the voltage of the rechargeable battery 50 via the measuring terminal 31, and pauses charging the rechargeable battery 50.

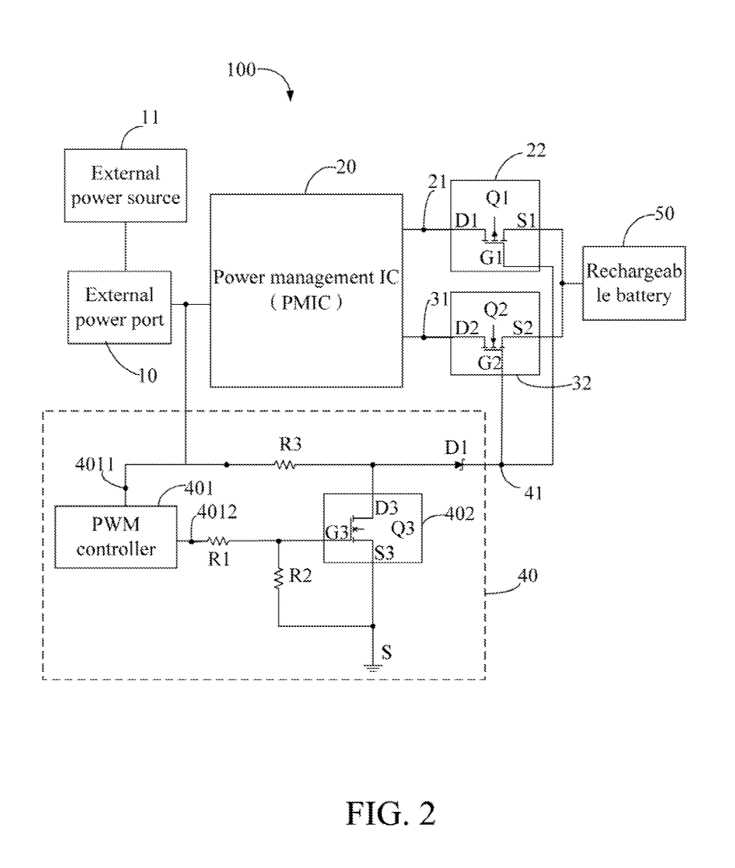

Referring to FIG. 2, in the embodiment, the control circuit 40 includes a pulse width modulation (PWM) controller 401. The PWM controller 401 includes a power terminal 4011 and a pulse signal output terminal 4012. The power terminal 4011 is connected to the external power port 10. The PWM controller 401 outputs a pulse signal via the pulse signal output terminal 4012, such that the control circuit 40 periodically changes the output modulated signal, to enable the charging process and the voltage measuring process to be performed alternately.

The control circuit 40 further includes a control switch 402. In the embodiment, the control switch 402 and the voltage measuring switch 32 are both high voltage activated switches, and the charging switch 22 is a low voltage activated switch. The control switch 402, the charging switch 22, and the voltage measuring switch 32 all include a control terminal, a first path terminal, and a second path terminal.

In one embodiment, the charging switch 22 is a P-channel Metal-Oxide-Semiconductor Field-Effect Transistor (PMOSFET) Q1, the voltage measuring switch 32 and the control switch 402 are N-channel Metal-Oxide-Semiconductor Field-Effect Transistors (NMOSFETs) Q2 and Q3 respectively. Gates, sources, and drains of the MOSFETs Q1, Q2 and Q3 constitute the control terminals, the first path terminals, and the second path terminals of the charging switch 22, the voltage measuring switch 32, and the control switch 402 respectively.

To illustrate with embodiments, the gate of the NMOSFET Q3 is symbolically denominated as node G3, which connects to the pulse signal output terminal 4012 via a resistor R1, to receive the pulse signal output from the PWM controller 401. The node G3 further connects with a ground node S via a resistor R2, and the source of the NMOSFET Q3 is symbolically denominated as node S3, which connects to the ground node S. The drain of the NMOSFET Q3 is symbolically denominated as node D3, which connects to the gates of the NMOSFET Q2 and the PMOSFET Q1 via a stabilivolt tube D4. The gates of the NMOSFET Q2 and the PMOSFET Q1 also connect to the external power port 10 via the stabilivolt tube D4 and a resistor R3. The drain of the NMOSFET Q2 (namely D2) connects to the voltage measuring terminal 31 of the PMIC 20. The source of the NMOSFET Q2 (namely S2) connects to the rechargeable battery 50. The drain of the PMOSFET Q1 (namely D1) connects to the charging terminal 21 of the PMIC 20, and the source of the PMOSFET Q1 (namely S1) connects to the rechargeable battery 50.

If the PWM controller 401 outputs a high voltage signal, the gate of the NMOSFET Q3 (namely G3) obtains a high voltage and controls the NMOSFET Q3 to switch on. The gates of the PMOSFET Q1 and the NMOSFET Q2 are both connected to the ground node S by the NMOSFET Q3 and obtain a low voltage, namely the control circuit 40 outputs the first modulated signal, so that the PMOSFET Q1 is switched on, and the PMIC 20 charges the rechargeable battery 50, and the NMOSFET Q2 is switched off, and the PMIC 20 pauses measuring the voltage of the rechargeable battery 50.

If the PWM controller 401 outputs a low voltage signal, the gate of the NMOSFET Q3 (namely G) obtains a low voltage and controls the NMOSFET Q3 to switch off. The gates of the PMOSFET Q1 and the NMOSFET Q2 are both connected to the external power source via the stabilivolt tube D4, the resistor R3 and the external power port 10 and obtain a high voltage, namely the control circuit 40 outputs the second modulated signal, so that the PMOSFET Q1 is switched off, and the PMIC 20 pauses charging the rechargeable battery 50, and the NMOSFET Q2 is switched on, and the PMIC 20 measures the voltage of the rechargeable battery 50. During the process of measuring the voltage of the rechargeable battery 50, there is no charging current flowing through the rechargeable battery 50, as a result there is no voltage drop in the rechargeable battery 50, and thus the voltage measured by the PMIC 20 is the real voltage of the rechargeable battery 50.

The PMIC 20 also compares the measured voltage of the rechargeable battery 50 with a predetermined voltage, to determine whether the rechargeable battery 50 is fully charged. When the voltage of the rechargeable battery 50 reaches the predetermined voltage, the PMIC 20 determines that the rechargeable battery 50 is fully charged, and disables the charging terminal 21, to stop outputting charging current to the rechargeable battery 50.

In another embodiment, the charging switch 22, the voltage measuring switch 32, and the control switch 402 can be bipolar junction transistors (BJTs). The charging switch 22 can be a pnp BJT, and the voltage measuring switch 32 and the control switch 402 can be npn BJTs. Bases, emitters, and collectors of the pnp BJT and the npn BJTs constitute the control terminals, the first path terminals, and the second path terminals, respectively, of the charging switch 22, the voltage measuring switch 32, and the control switch 402.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A rechargeable battery checker for measuring the voltage of a rechargeable battery, comprising:
a PMIC comprising a charging terminal and a voltage measuring terminal;
a charging switch connected to the charging terminal and the rechargeable battery, to control the PMIC to charge or pause charging the rechargeable battery;
a voltage measuring switch connected to the voltage measuring terminal and the rechargeable battery, to control the PMIC to measure or pause measuring the voltage of the rechargeable battery;
a control circuit connected to the charging switch and the voltage measuring switch, and to output a modulated signal, and periodically change the signal to switch on/off the charging switch and the voltage measuring switch, wherein the modulated signal comprises a first modulated signal and a second modulated signal; and
an external power port configured for connecting an external power source to power the PMIC and the control circuit;
wherein, when the control circuit outputs the first modulated signal, the charging switch is switched on, and the voltage measuring switch is switched off, the PMIC charges the rechargeable battery, and pause measuring the voltage of the rechargeable battery;
when the control circuit outputs the second modulated signal, the voltage measuring switch is switched on, and the charging switch is switched off, the PMIC measures the voltage of the rechargeable battery, and pause charging the rechargeable battery; and
the PMIC determines whether the rechargeable battery is fully charged according to the measured voltage of the rechargeable battery.

2. The rechargeable battery checker as described in claim 1, wherein the control circuit comprises a PWM controller, the PWM controller comprises a pulse signal output terminal, the PWM controller outputs a pulse signal from the pulse signal output terminal, such that the control circuit periodically changes the output the modulated signal, to enable the charging process and the voltage measuring process to be performed alternately.

3. The rechargeable battery checker as described in claim 2, wherein the control circuit further comprises a control switch.

4. The rechargeable battery checker as described in claim 3, wherein the control switch and the voltage measuring switch are both high voltage activated switches, and the charging switch is a low voltage activated switch.

5. The rechargeable battery checker as described in claim 4, wherein the control switch, the charging switch, and the voltage measuring switch all comprise a control terminal, a first path terminal, and a second path terminal.

6. The rechargeable battery checker as described in claim 5, wherein the control terminal of the control switch connects to the pulse signal output terminal, to receive the pulse signal outputted from the PWM controller, the first path terminal of the control switch connects to a ground node, the second path terminal of the control switch connects to the control terminals of the charging switch and the voltage measuring switch; the control terminals of the charging switch and the voltage measuring switch also connect to the external power port.

7. The rechargeable battery checker as described in claim 6, wherein when the PWM controller outputs a high voltage signal, the control switch and the charging switch are switched on, the PMIC charges the rechargeable battery, and the voltage measuring switch is switched off, and the PMIC pauses measuring the voltage of the rechargeable battery;
when the PWM controller outputs a low voltage signal, the control switch and the charging switch are switched off, the PMIC pauses charging the rechargeable battery, and the voltage measuring switch is switched on, and the PMIC measures the voltage of the rechargeable battery.

8. The rechargeable battery checker as described in claim 5, wherein the charging switch is a PMOSFET, the voltage measuring switch and the control switch are NMOSFETs, gates, sources, and drains of the PMOSFET and the NMOSFETs constitute the control terminals, the first path terminals, and the second path terminals of the charging switch, the voltage measuring switch, and the control switch respectively.

9. The rechargeable battery checker as described in claim 5, wherein the charging switch is a pnp BJT, and the voltage measuring switch and the control switch are npn BJTs, bases, emitters, and collectors of the pnp BJT and the npn BJTs constitute the control terminals, the first path terminals, and the second path terminals, respectively, of the charging switch, the voltage measuring switch, and the control switch.

10. The rechargeable battery checker as described in claim 1, wherein the PMIC compares the measured voltage of the rechargeable battery with a predetermined voltage, when the voltage of the rechargeable battery reaches the predetermined voltage, the PMIC determines that the rechargeable battery is fully charged, and disable the charging terminal, to stop outputting charging current to the rechargeable battery.
